(19) United States
(12) Patent Application Publication
(10) Pub. No.: US 2002/0054949 A1
(43) Pub. Date: May 9, 2002

(54) Fiber formulation

(76) Inventors: Samuel L. Forusz, Westlake Village, CA (US); Rukhsana Arastu, Northridge, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/917,494

(22) Filed: Jul. 26, 2001

Related U.S. Application Data
(60) Provisional application No. 60/221,629, filed on Jul. 28, 2000.

(51) Int. Cl. A23L 2/00

(52) U.S. Cl. 426/590; 426/72; 426/615

(57) ABSTRACT

The invention relates to a composition and a method of administering a composition suitable for human consumption. In one embodiment, the composition includes a dietary acceptable amount of a first fiber comprising inulin and a dietary acceptable amount of a second soluble fiber. The composition is in beverage form having a viscosity on the order of 1.4 cp or less. A serving of the beverage may comprise a portion, including the entire portion of a daily predetermined amount of soluble fiber.

### BACKGROUND

This application claims the benefit of the earlier filing date of provisional application of Samuel L. Forusz and Rukhsana Arastu entitled, “Fiber Formulation,” filed Jul. 28, 2000, Serial No. 60/221,629 and incorporated herein by reference.

1. Field

The invention relates to nutritional supplements and, more particularly, to a composition and method for dietary fiber administration.

2. Description of Related Art

The Food and Nutrition Board of the National Academy of Scientist has not set a Recommended Dietary Allowance (RDA) for dietary fiber. Nevertheless, the importance of dietary fiber is recognized by most health organizations and the federal government. The Dietary Guidelines for Americans published jointly by the United States Departments of Agriculture and Health and Human Services recommend eating foods that have adequate amounts of fiber. The National Cancer Institute recommends 20 to 30 grams of fiber per day with an upper limit of 35 grams.

Dietary fiber is plant material that is resistant to breakdown (digestion) by the human digestive system. In general, there are two major kinds of dietary fiber-insoluble (cellulose, hemicellulose, lignin) and soluble (gums, mucilages, pectins). Insoluble fiber promotes normal elimination by providing bulk for stool formation and hastening the passage of the stool through the colon. Studies indicate that soluble fibers may play a role in reducing the level of cholesterol in the blood.

What is needed are compositions and methods of administration that encourage fiber consumptions.

### SUMMARY

A composition and a method of administering a composition suitable for human consumption is described. In one embodiment, the composition includes a dietary acceptable amount of a first soluble fiber comprising inulin and a dietary acceptable amount of at least a second soluble fiber. The composition is in beverage form having a viscosity on the order of 1.4 centipoise (cp) or less. A serving of the beverage may comprise a portion, including the entire portion of a daily predetermined amount of soluble fiber.

### DETAILED DESCRIPTION OF THE INVENTION

The following description relates to a composition suitable for human consumption and a method of administering a beverage composition. In one aspect, the composition serves as a dietary supplement to provide the dietary needs of fiber in men and women. By supplying fiber, particularly, soluble fiber, the composition and method promote regularity, intestinal health, and a lowering of the blood cholesterol level in men and women.

In one embodiment, the composition is a beverage formulated to contain active ingredients of a first soluble fiber including inulin and at least a second soluble fiber. The first fiber and at least a second fiber are contained at levels approaching 40 percent by weight per volume and a viscosity of 1.4 cp.

Inulin is a fructooligosaccharide derived principally from chickory root. Inulin is commercially available from Orafti of Malvern, Pa. One suitable second soluble fiber to be combined with inulin is maltodextrin derived from corn. Maltodextrin is manufactured by Archer Daniels Midland of Decatur, Ill., and is commercially available from Matsutani Chemical Industry Company, Ltd. of Decature, Ill. (Matsutani America, Inc.). Other suitable second soluble fibers include, but are not limited to, polydextrose and acacia gum, used alone or in combination with another second fiber.

In one embodiment, the composition is a fortified beverage formulated to contain active ingredients of inulin and other soluble fiber(s), and vitamin C. The beverage is non-carbonated and the delivery system may be in a ready-to-drink form or a concentrated form to be mixed with a fluid such as water or juice. A pH of the product ranges from about 4.0-4.6, and preferably about 4.1 to about 4.4. At this pH range, inulin and the other soluble fiber(s) such as maltodextrin are stable in solution and the acidic nature controls bacteria growth.

In one embodiment where the second soluble fiber is maltodextrin, the composition comprises:

about 0.26 to 6.0% (w/v) of inulin in a soluble form;

about 0.0026 to 33% (w/v) of maltodextrin;

about 0.013 to 0.26% (w/v) of ascorbic acid;

about 0.009 to 0.56% (w/v) of citric acid;

about 0.003 to 0.14% (w/v), sodium citrate, preferably granular form;

about 0.002 to 0.012% (w/v), sodium ascorbate;

different levels of sugars for different flavors used in the beverage product;

and appropriate levels of flavors which can be, but not limited to, orange, peach, cranberry, tangerine, raspberry, grapefruit, mango, black cherry, strawberry, or any combination of the above flavors. The colorants can be from natural sources or from certified F&DC colorants depending on labeling claim being sought.

In the above embodiment, the flavor choices are selected for preferred compatibility with the other ingredients, especially the active ingredients of inulin, second fiber(s), and vitamin C. Sodium ascorbate, sodium citrate and citric acid maintain a pH from about 4.1 to about 4.4. Tables 1-3 present several examples of beverage compositions with different colors and flavors.

The composition may be prepared as a single strength composition for consumption or as a concentrate to be mixed with a fluid prior to consumption. By single strength, the composition represents a predetermined periodic amount, including a predetermined daily amount or a portion of a predetermined daily amount of active ingredients (e.g., inulin, second fiber, and vitamin C).

To prepare a single strength composition, a sweetener (if utilized) is added to a volume of water equivalent to about 40 percent by weight of a final composition. To the mixed water and sweetener, inulin is added and mixed well. Next, a desired amount of soluble fiber is added and mixed until completely dissolved. Citric acid, sodium citrate dihydrate, and ascorbic acid are sequentially added and stirred until little or no particulates remain (e.g., the solution appears translucent). Optional flavors and colorants are added and mixed and the composition is adjusted with water to achieve the desired volume of, for example, 300 milliliters (mL) or 10 ounces (oz).

A concentrated composition may be prepared in the following manner. A volume of water equivalent to 20 percent by weight for volume of the final composition is combined with a sweetener (if utilized). To this composition, inulin and other fiber(s) are added and mixed, followed by, sequentially, citric acid, sodium citrate dihyrate, sodium ascorbate, and ascorbic acid. Flavors and colorants, where desired, are added to the composition, with agitation. Finally, the desired volume is achieved by adjusting with water.

The beverage can be prepared in low calorie form, substituting sweeteners such as sugar, with artificial sweeteners such as aspartame, acesulfame-K, or sucralose. The beverage can be pasteurized through tunnel pasteurization or hot fill. Cold-fill in conjunction with preservation can also be achieved by addition of preservatives such as potassium benzoate, potassium sorbate. Slight carbonation can be performed with about 2 to 2.5 volumes. The beverages can also be made in a dry-mix powder and prepared by mixing with water or juice. For example, a 18.0 g of dry-mix powder of 4.4 g inulin, 13.0 g of soluble fiber, and 0.2 g of ascorbic acid may be combined with 300 mL of water to provide a single-strength drink.

The composition described above generally relates to low viscosity soluble fiber composition. In this manner, the composition does not effect the absorption of minerals, unlike typical high viscosity fibers. In general, as viscosity is increased, the rate of absorption/diffusion of minerals is reduced. The composition described above as a beverage provides the nutrients for promoting intestinal health and lowering blood cholesterol levels. Addition of vitamin C utilizes the absorbed calcium and maintains normal calcium crystals in the bones.

None of the available beverage compositions known to the inventors include inulin and fiber in such a concentrated form and yet have such a low viscosity as described in the composition as a beverage described above. According to the inventors' best knowledge, there is no such beverage product in the market that has low viscosity with such a high concentration of fiber. The beverage lies midway between a natural medicine and a refreshing beverage to gain broader consumer acceptance. The liquid formulation is beneficial to most human subjects, particularly adult human subjects including elderly human subjects, who may have difficulties in taking solid dosage forms for regularity.

Tables 1-3 present representative examples of the composition of the invention.

TABLE 1
Formula for Peach - Pear Flavored Beverage

| | AMOUNT, g |
|---|---|
| | (per serving from |
| INGREDIENT | about 8 to 10 oz) |
| Maltodextrin | 13.0 |
| Inulin | 4.4 |
| Sugar | 18.0 |
| Citric acid | 0.138 |
| Sodium citrate, dihydrate granular | 0.2 |
| Ascorbic acid | 0.2 |
| Natural Pear flavor | 0.374 |
| Natural peach flavor | 1.52 |
| Natural fruity red colorant, liquid | 0.0399 |
| Natural caramel colorant | 0.084 |
| Sodium Ascorbate | 0.035 |

TABLE 2
Formula for Apple Flavored Beverage

| | AMOUNT, g |
|---|---|
| | (per serving from |
| INGREDIENT | about 8 to 10 oz) |
| Maltodextrin | 13.0 |
| Inulin | 4.4 |
| Sugar | 18.45 |
| Citric acid | 0.12 |
| Sodium citrate, dihydrate granular | 0.17 |
| Ascorbic acid | 0.2 |
| Natural Apple fruit flavor | 0.69 |
| Natural caramel colorant | 0.087 |
| Sodium Ascorbate | 0.035 |

TABLE 3
Formula for Berry Blend Flavored Beverage

| | AMOUNT, g |
|---|---|
| | (per serving from |
| INGREDIENT | about 8 to 10 oz) |
| Maltodextrin | 13.0 |
| Inulin | 4.4 |
| Sugar | 18.0 |
| Citric acid | 0.144 |
| Sodium citrate, dihydrate granular | 0.17 |
| Ascorbic acid | 0.2 |
| Natural strawberry flavor | 1.32 |
| Natural Berry flavor | 0.298 |
| Natural fruity red colorant, liquid | 0.6 |
| Sodium Ascorbate | 0.035 |

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. A composition suitable for human consumption comprising:
a dietary acceptable amount of a first soluble fiber comprising inulin; and
a dietary acceptable amount of a second soluble fiber,
wherein the composition is a beverage having a viscosity on the order of 1.4 centipoise or less.

2. The composition of claim 1, wherein the dietary acceptable amount of the first fiber comprises about 0.26 to six percent by weight of a beverage volume.

3. The composition of claim 1, wherein the dietary acceptable amount of the second fiber comprises about 0.0026 to 33 percent by weight of a beverage volume.

4. The composition of claim 1, further comprising a dietary acceptable amount of ascorbic acid.

5. The composition of claim 1, wherein the composition has a pH less than six.

6. A method comprising:
administering a beverage composition suitable for human consumption comprising:
a dietary acceptable amount of a first soluble fiber comprising inulin; and
a dietary acceptable amount of a second soluble fiber,
wherein the composition has a viscosity on the order of 1.4 cp or less and represents a portion of a daily predetermined amount of soluble fiber.

7. The method of claim 6, wherein the portion represents less than the daily predetermined amount of soluble fiber.

8. The method of claim 6, prior to administering, further comprising:
preparing the beverage composition from a dry mix by combining with a liquid.

9. The method of claim 8, wherein the dry mix is combined with water.
